(19) United States
(12) Patent Application Publication
(10) Pub. No.: US 2019/0329443 A1
(43) Pub. Date: Oct. 31, 2019

(54) Canter Head and Reversible Knife Therefor

(71) Applicant: DK-SPEC INC., Saint-Nicolas (CA)

(72) Inventors: Clermont LEVASSEUR, St-Antoine de Tilly (CA); Thomas LEVASSEUR, Quebec (CA); Marius SIRBU, St-Agapit (CA); Guillaume GRENIER, Scott (CA)

(21) Appl. No.: 16/395,058

(22) Filed: Apr. 25, 2019

Related U.S. Application Data
(60) Provisional application No. 62/662,940, filed on Apr. 26, 2018.

(51) Int. Cl. B27L 11/00

(52) U.S. Cl. CPC B27L 11/007; B27L 11/005

(57) ABSTRACT

There is provided a canter head. There is also provided a canter head including at least one reversible knife, as well as a reversible knife for a canter head.

### TECHNICAL FIELD

The invention relates to a canter head, and more specifically to a canter head including at least one reversible knife. The invention also relates to a reversible knife for a canter head.

### BACKGROUND

Canters are machine used in the wood processing industry to transform a log with a generally circular cross-section into a piece of wood with planar sides.

A canter usually includes one or more rotating canter heads often regrouped by pairs, the two canter heads of a same pair being mirror images of one another and rotating in opposite directions. Each canter head includes one or more series of knives and is configured to rotate about a rotation axis which is perpendicular to the longitudinal axis of the log.

Canter heads can have various configurations. In one such configuration, the canter head in rotation defines the general the shape of a shallow truncated cone. Each cutter head is typically fitted with a variable number of knife holders, each of them carrying a set of two knives, extending at an angle relative to one another, namely a chipping knife and a finishing knife. The chipping knife tends to be longer and extends at an angle relative to the rotation axis, to sever a slice of wood to make wood chips. The finishing knife tends to be shorter and extends along a plane generally perpendicular to the rotations axis, and functions to smooth the cant.

As the canter head is operated, the chipping and finishing knives are prone to wear and tear, which cause their respective cutting edges to round up and to become less efficient. To avoid losing efficiency, the canter head is stopped and the chipping and/or finishing knives are machined to sharpen their cutting edges. In some other instances, the chipping and/or finishing knives are provided with both a leading edge and a trailing edge, and can be positioned on the canter head such that either the leading edge or the trailing edge is used during operation. One example of a reversible clipping knife is provided in U.S. Pat. No. 5,709,255. While such a reversible configuration tends to reduce the episodes and amount of time during which the canter head is shut down for machining each knife, the operation of the canter head still ends up in the rounding up of the cutting edges. Furthermore, the operation of the canter head tends to lead to accumulation of wood chips or particles between the chipping knife and the finishing knife, which reduces the efficiency of the canter head.

To alleviate the drawbacks associated with such an accumulation of wood residues between the chipping and finishing knives, some have proposed a unitary knife construction. An example of such unitary knife construction is illustrated and described in U.S. Pat. No. 8,684,051 where a cutting knife includes a long chipping face, a finishing face and a curbed face connecting the chipping face to the finishing face. While such a configuration may contribute to reduce accumulation of wood residues between the chipping and finishing portions, it is still subject to rounding up during the operation of the canter head. And since some portions of the unitary knife are more subject to wear and tear (e.g. the chipping portion), maintaining the efficiency of the entire cutting knife may require the replacement of the entire unitary knife while some portions may still be adequate for proper operation of the canter head. Therefore, such a unitary configuration may sometimes prove to be less economical.

Therefore, it would be desirable to be provided with a canter head configuration that alleviates at least some of the above-identified drawbacks.

### SUMMARY

According to one broad aspect, there is provided a canter head comprising:

a. a hub;

b. at least one knife holder attached to the hub and including a finishing portion and a chipping portion, the finishing portion including a receptacle for receiving a corresponding finishing knife;

c. at least one reversible finishing knife receivable in the receptacle of the at least one knife holder, the at least one reversible finishing knife including a leading edge and a trailing edge;

d. at least one projection extending from one of the at least one reversible finishing knife or the at least one receptacle;

e. at least one recess defined in the other of the at least one reversible finishing knife or the at least one receptacle, the at least one recess being configured to receive the at least one projection therein for preventing unwanted movement of the at least one finishing knife relative to the at least one knife holder during the operation of the canter head, the at least one projection and the corresponding at least one recess being configured to allow both the leading edge and the trailing edge of the finishing knife to be in a forward operating position;

f. at least one finishing knife clamp mountable to the finishing portion of the at least one knife holder, the at least one finishing knife clamp being configured for clamping the at least one finishing knife onto the finishing portion of the at least one knife holder;

g. at least one chipping knife mountable to the chipping portion of the at least one knife holder; and

h. at least one chipping knife clamp mountable to the chipping portion of the at least one knife holder, the at least one chipping knife clamp being configured for clamping the at least one chipping knife onto the chipping portion of the at least one knife holder.

In one feature, the finishing portion of the at least one knife holder includes a receptacle having a top face and the at least one finishing knife comprises a bottom face and a top face extending between the leading edge and the trailing edge. In this aspect, the bottom face of the finishing knife is configured to mate with the top face of the receptacle. Preferably, the top face of the receptacle defines a V-shape and the bottom face of the finishing knife define a complementary V-shape.

In another feature, the at least one projection extends upwardly from the finishing knife portion and the recess is defined on the finishing knife.

According to yet another feature, the at least one projection has an oblong shape and the at least one recess has a complementary oblong shape.

In a further feature, the receptacle includes a pair of spaced-apart channels and the finishing knife includes a pair of spaced-apart flanges. In this feature, the spaced-apart flanges of the finishing knife are receivable in the spaced-apart channels of the receptacle.

In another feature, the canter head comprises two knife holders. Preferably, the two knife holders extend from the hub in radially opposed directions.

According to another broad aspect, there is provided a reversible finishing knife for canter head including at least one knife holder attached to a hub, the knife holder including a finishing portion including a receptacle for receiving the finishing knife. In this aspect, the reversible knife comprises a leading edge and a trailing edge, and at least one of a projection and a recess configured to engage the other one of a complementary recess and a projection on the at least one knife holder.

In one feature, the at least one projection extends from the knife holder and the at least one corresponding recess is defined in the finishing knife.

In another feature, the at least one projection comprises an oblong projection.

In yet another feature, the finishing knife comprises a pair of flanges, each flange extending on one side of the finishing knife, between the leading edge and the trailing edge thereof.

In one feature, the canter head comprises two knife holders attached to the hub. Preferably, the two knife holders are attached to the hub and extend in radially opposed directions.

In yet another feature, the canter head comprises four knife holders attached to the hub. Preferably, the knife holders are symmetrically distributed about the periphery of the canter head.

### BRIEF DESCRIPTION OF THE DRAWINGS

Reference will now be made to the accompanying drawings, showing by way of illustration example embodiments thereof and in which:

FIG. 1A is a top, front perspective view of a canter head configured to rotate in a counter-clockwise direction, in accordance with one embodiment;

FIG. 1B is a top, front perspective view of a canter head configured to rotate in a clockwise direction, in accordance with one embodiment;

FIG. 2 is another top, front perspective view of the canter head shown in FIG. 1A;

FIG. 3 is a front elevation view of the canter head shown in FIG. 1A;

FIG. 4 is a top plan view of the canter head shown in FIG. 1A;

FIG. 5 is a bottom plan view of the canter head shown in FIG. 1A;

FIG. 6 is a left elevation view of the canter head shown in FIG. 1A;

FIG. 7 is a right elevation view of the canter head shown in FIG. 1A;

FIG. 8 is an enlarged, front perspective view of the canter head shown in FIG. 1A, for better showing the left knife holder, as well as the finishing knife, the chipping knife, the finishing knife clamp and the chipping knife clamp attached thereto;

FIG. 9 is a top left perspective, partially exploded view of the canter head shown in FIG. 1A;

FIG. 10 is a bottom left perspective, partially exploded view of the canter head shown in FIG. 1A;

FIG. 11 is an exploded view of the canter head shown in FIG. 1A;

FIG. 12 is a top, front perspective view of a canter head hub in accordance with one embodiment;

FIG. 13 is a bottom perspective view of the canter head hub shown in FIG. 12;

FIG. 14 is a front elevation view of the canter head hub shown in FIG. 12;

FIG. 15 is a top plan view of the canter head hub shown in FIG. 12;

FIG. 16 is a bottom plan view of the canter head hub shown in FIG. 12;

FIG. 17 is a left elevation view of the canter head hub shown in FIG. 12;

FIG. 18 is an enlarged top perspective view of the canter head shown in FIG. 12, for better showing the left knife holder;

FIG. 19 is a cross-section, perspective view of the finishing portion of the canter head shown in FIG. 4;

FIG. 20 is a cross-section, side view of the finishing portion of the canter head shown in FIG. 19;

FIG. 21 is a top perspective view of a finishing knife in accordance with one embodiment;

FIG. 22 is a bottom perspective of the finishing knife shown in FIG. 21;

FIG. 23 is a top plan view of the finishing knife shown in FIG. 21;

FIG. 24 is a front elevation view of the finishing knife shown in FIG. 21;

FIG. 25 is a bottom plan view of the finishing knife shown in FIG. 21;

FIG. 26 is a left elevation view of the finishing knife shown in FIG. 21;

FIG. 27 is a bottom perspective view of a finishing knife clamp in accordance with one embodiment;

FIG. 28 is a top perspective view of the finishing knife clamp shown in FIG. 27;

FIG. 29 is a top plan view of the finishing knife clamp shown in FIG. 27;

FIG. 30 is a left elevation view of the finishing knife clamp shown in FIG. 27;

FIG. 31 is a top, rear perspective view of a chipping knife in accordance with one embodiment;

FIG. 32 is a left-elevation view of the chipping knife shown in FIG. 31;

FIG. 33 is a top perspective view of a chipping knife clamp in accordance with one embodiment;

FIG. 34 is a top plan view of the chipping knife clamp shown in FIG. 33;

FIG. 35 is a left elevation view of the chipping knife clamp shown in FIG. 33;

FIG. 36 is a cross-section, perspective view of the chipping portion of the canter head shown in FIG. 4;

FIG. 37 is a top perspective view of a canter head in accordance with another embodiment;

FIG. 38 is a top perspective, partially exploded view of the canter head shown in FIG. 37;

FIG. 39 is a top perspective view of a canter head hub, in accordance with one embodiment;

FIG. 40 is a bottom plan view of the canter head hub shown in FIG. 39;

FIG. 41A is a top perspective view of a finishing adaptor, in accordance with one embodiment;

FIG. 41B is a bottom perspective view of the finishing adaptor shown in FIG. 41A;

FIG. 42A is a top perspective view of a chipping adaptor, in accordance with one embodiment;

FIG. 42B is a bottom perspective view of the chipping adaptor shown in FIG. 42A;

and

FIG. 43 is a top perspective view of a radial knife adaptor, in accordance with one embodiment.

### DETAILED DESCRIPTION

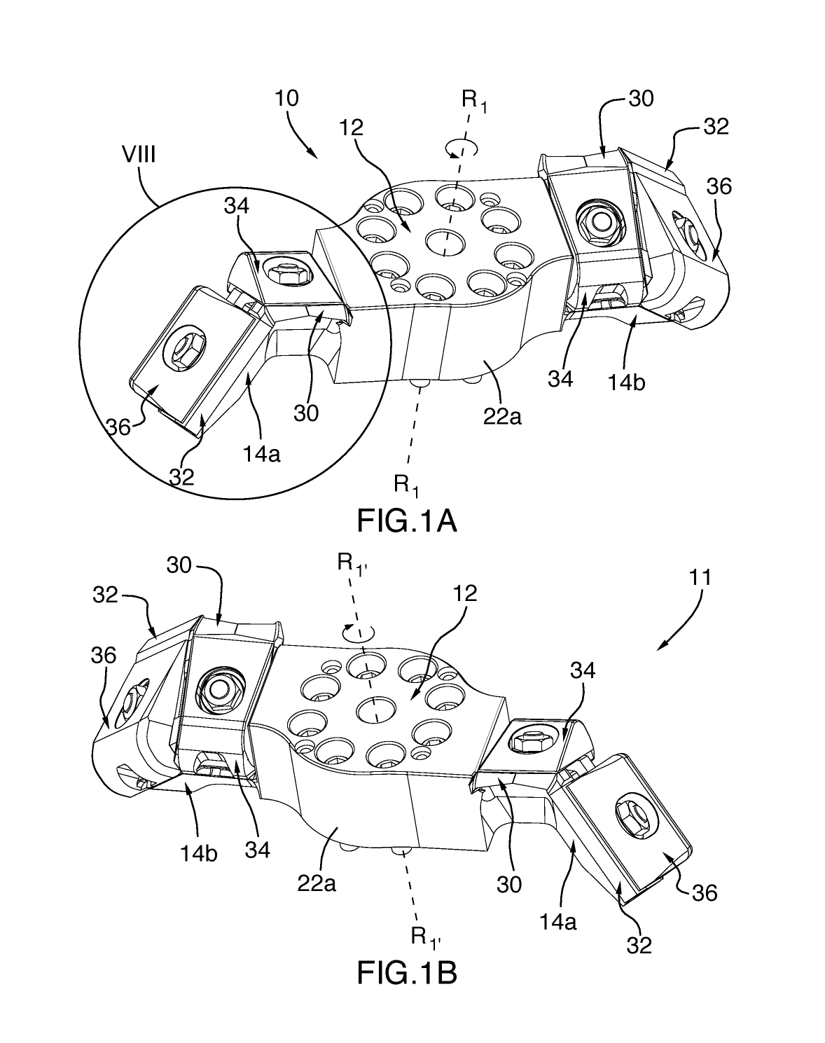

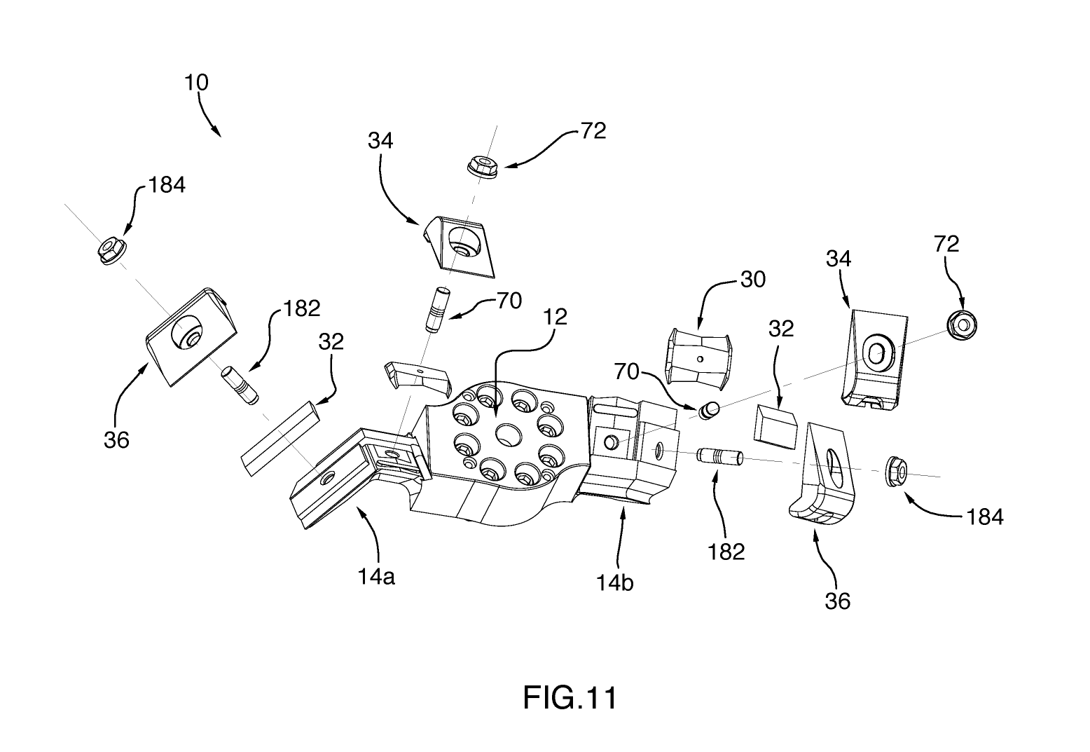

Referring first to FIGS. 1A to 11, 19 and 20 there is provided a canter head 10, in accordance with one embodiment of the present invention. In the embodiment illustrated in FIG. 1A, the canter head 10 is configured to rotate in a counter-clockwise direction about rotation axis R₁-R₁, while FIG. 1B, illustrates a canter head 11 configured to rotate about a rotation axis R_{1′}-R_{1′} in a clockwise direction. The person skilled in the art will appreciate that the description of the canter head 10 also applies to canter head 11, with proper adaptations.

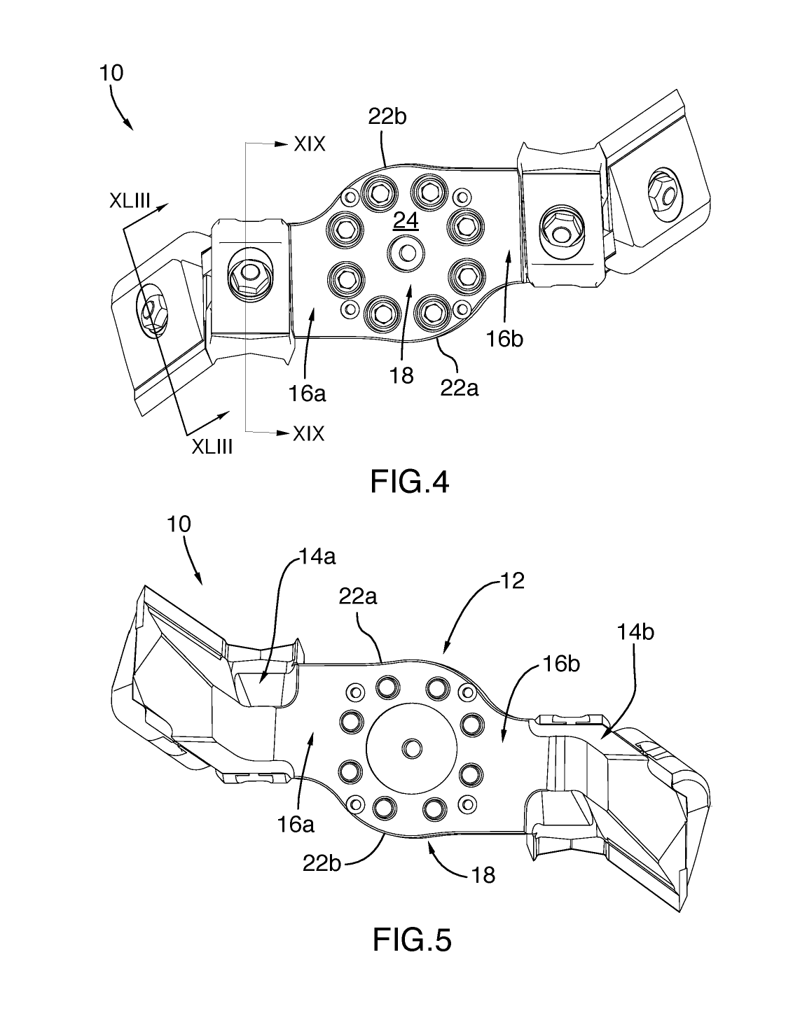

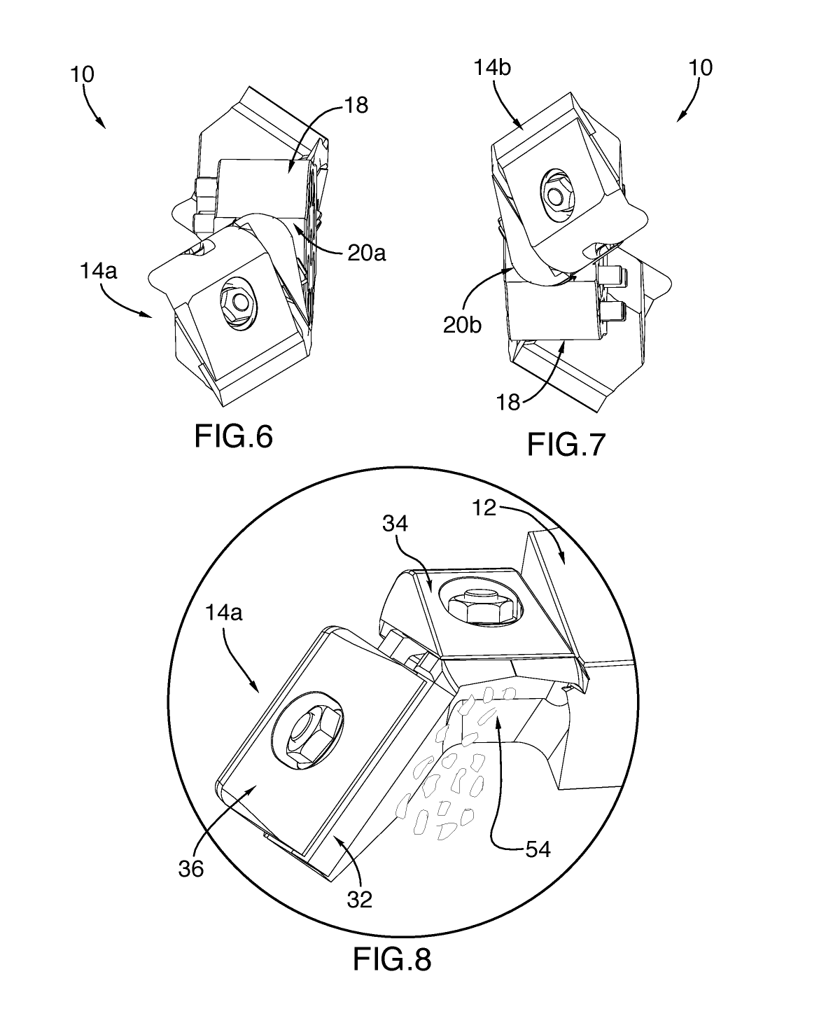

To facilitate the description of the canter head 10, reference will be made to the drawings in which the orientation will be arbitrarily designated as the top (FIG. 4), bottom (FIG. 5), front (FIG. 3), left (FIG. 6) and right (FIG. 7). While the orientation of the canter head 10 is arbitrarily described as such for the purpose of the specification, the person skilled in the art will appreciate that the canter head 10 can be used in all directions, and that the orientation arbitrarily selected for the purpose of the present specification is in no way intended to restrict or otherwise limit the configuration of the canter head 10 and the way it can be used.

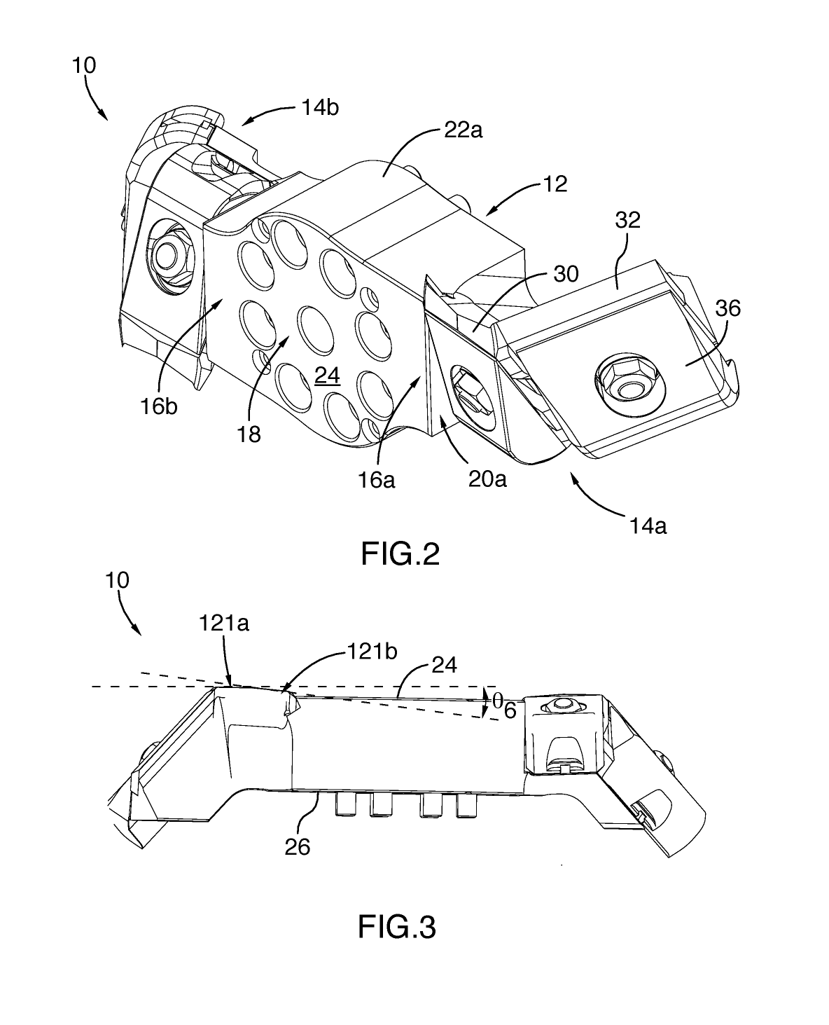

In the illustrated embodiment, the canter head 10 includes a central hub 12 and a plurality of knife holders 14a, 14b which extend radially outwardly from the hub 12. As illustrated in FIGS. 2, 4 and 5, hub 12 is generally elongated and includes first and second generally rectangular end portions 16a, 16b located opposite each other and a central bulbous 18 portion located between the first and second end portions 16a, 16b.

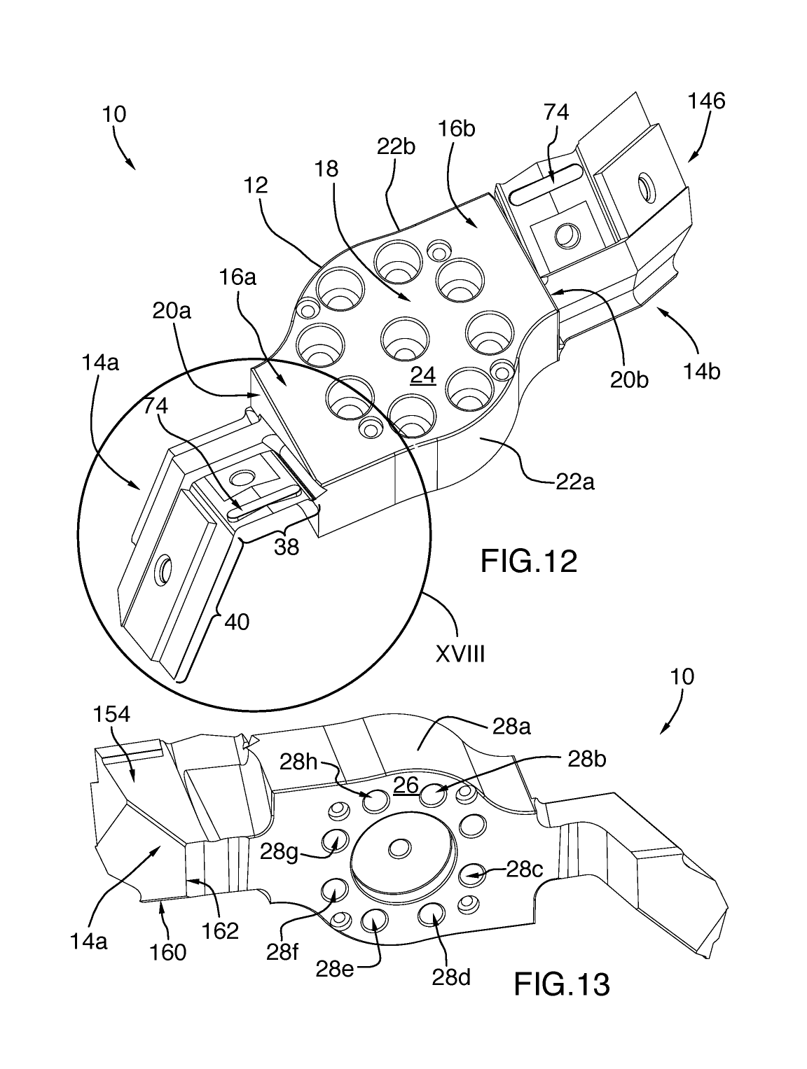

Best seen in FIGS. 12 and 13, the hub 12 further includes first and second end sidewalls 20a, 20b located respectively at the first and second end portions 16a, 16b, and lateral curved sidewalls 22a, 22b extending convexly away from each other to define the bulbous portion 18. The hub 12 further includes top and bottom faces 24, 26 extending parallel to each other and perpendicularly to the end sidewalls 20a, 20b and the lateral sidewalls 22a, 22b.

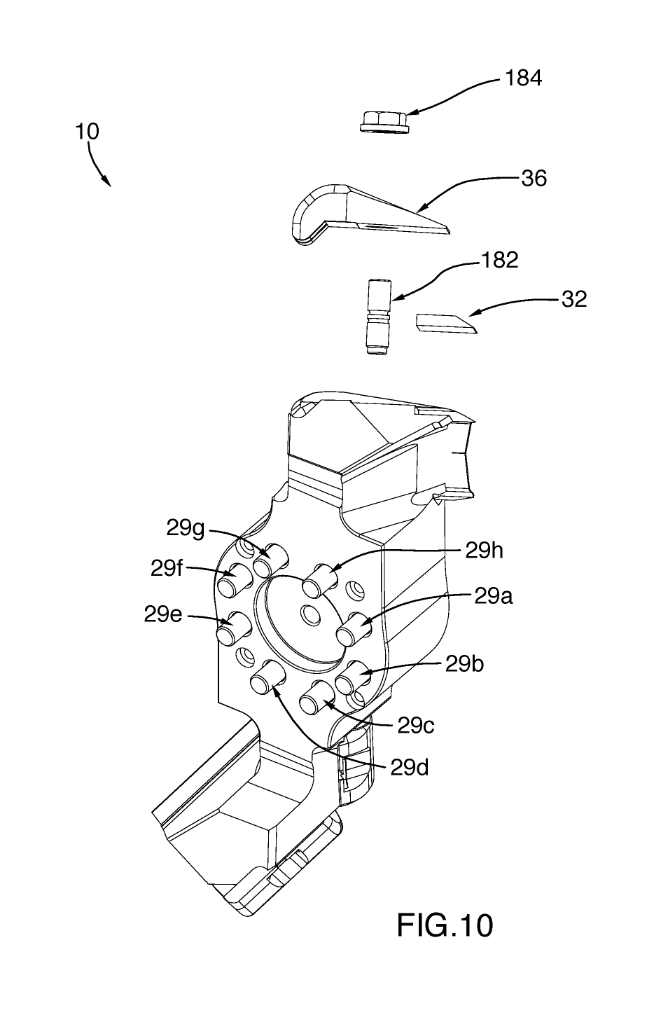

In the illustrated embodiment, the hub 12 further includes a plurality of counterbored holes 28a-28h extending from the top face 24 to the bottom face 26. Specifically, the counterbored holes 28a-28h are disposed in a circular pattern and are adapted to receive corresponding bolts (29a-29h—shown in FIG. 10) for mounting the canter head 10 to a rotating shaft coupled to a motor (not shown).

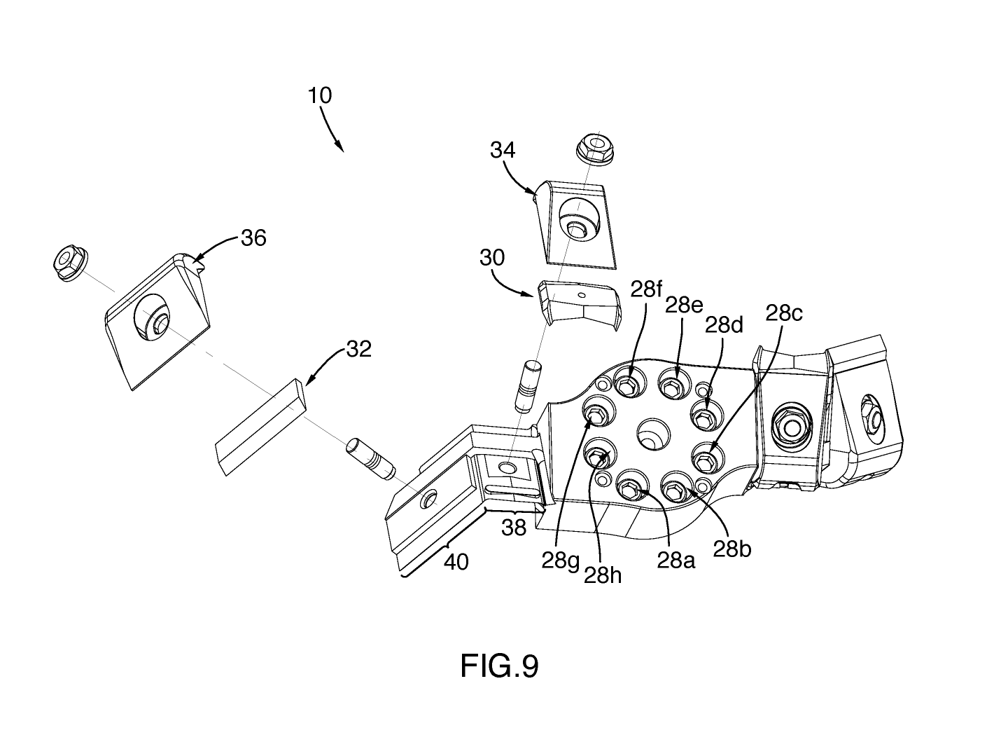

The two knife holders 14a, 14b being identical, only knife holder 14a will be described. The person skilled in the art will appreciate that the same description also applies to knife holder 14b, with proper adaptations. In the illustrated embodiment, and referring particularly to FIGS. 1 and 9, knife holder 14a is adapted to receive a finishing knife 30 and a chipping knife 32, as well as a finishing knife clamp 34 and a chipping knife clamp 36, adapted to hold the finishing and chipping knives 30, 32 onto the knife holder 14a. Knife holder 14a includes a first, finishing portion 38 extending radially from the hub 12 and perpendicularly to the rotation axis R₁-R₁ of the canter head 10, for mounting finishing knife 30, and a second, chipping portion 40, extending angularly from the finishing portion 38 (and as seen from FIGS. 1, 4, 5 and 9, downwardly and forwardly from the finishing portion 38) for mounting chipping knife 32. In the illustrated embodiment, an angle θ₁ is defined by a longitudinal axis L₁ extending perpendicular to the rotation axis R₁-R₁ of the finishing portion 38 and a longitudinal axis L₂ extending along the chipping portion 40 (see FIG. 14). In one embodiment, the angle θ₁ ranges from 40 degrees to 70 degrees, but is preferably about 55 degrees. A person skilled in the art will understand that a different angle θ₁ could be used without departing from the scope of the invention.

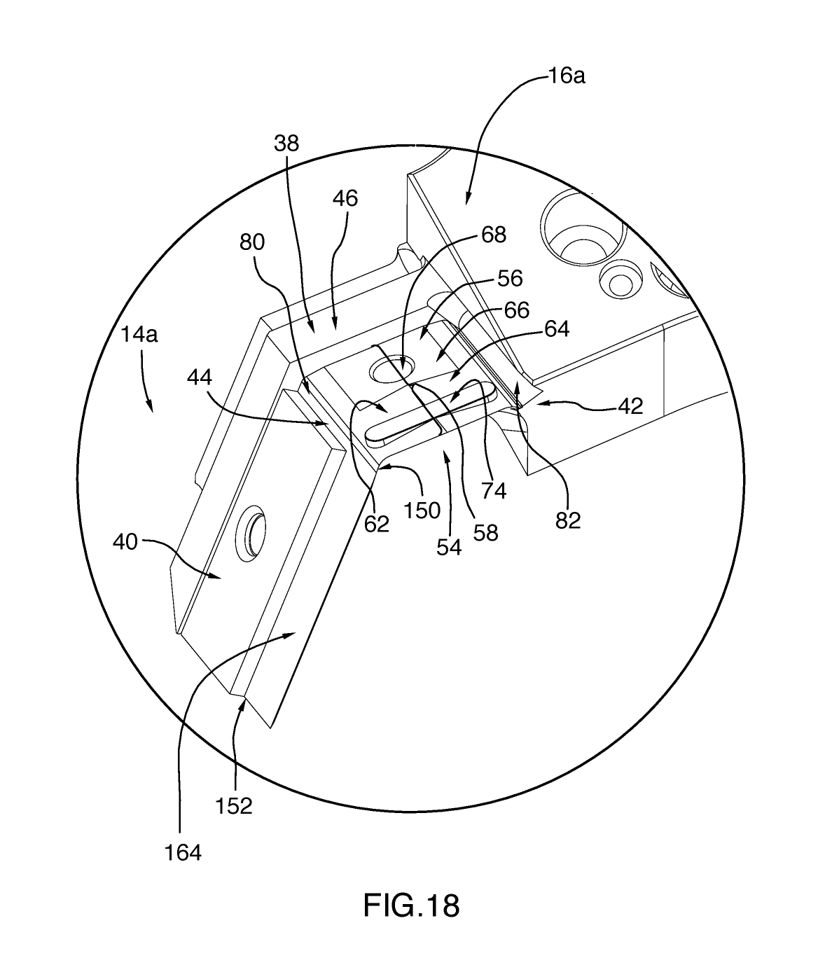

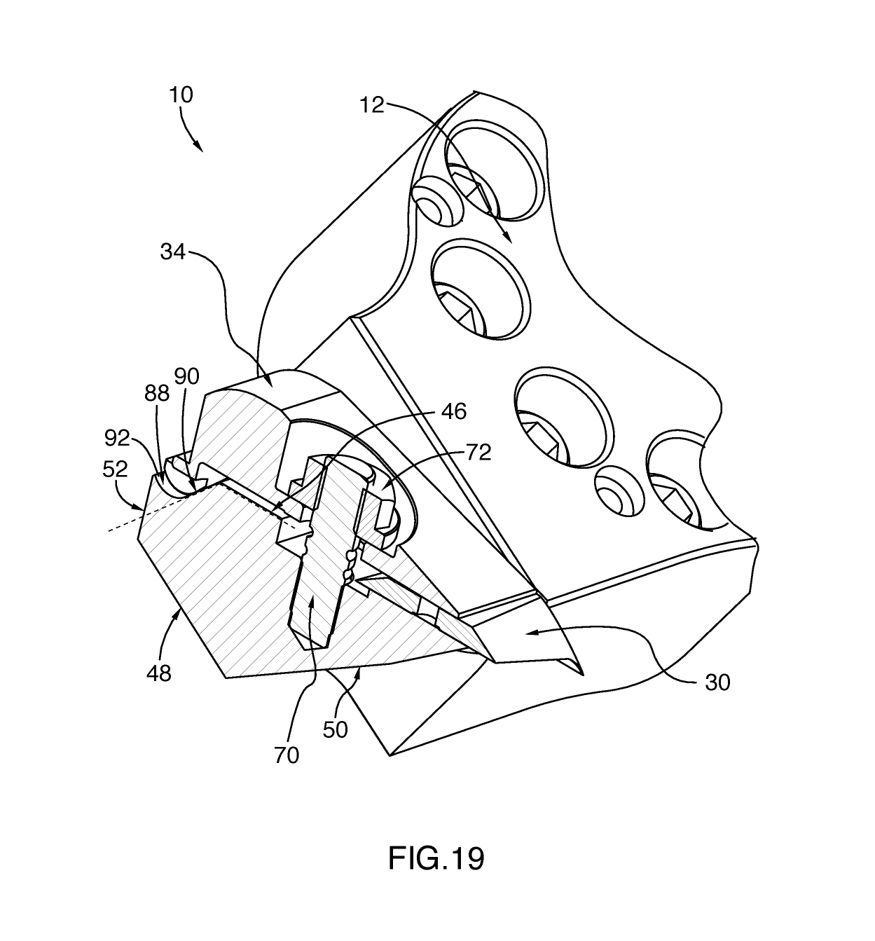

With reference to FIGS. 18 to 20, the finishing portion 38 of the knife holder 14a includes a right end 42 in connection with the hub 12 of the canter head 10, and a left end 44 in connection with the chipping portion 40. The finishing portion 38 also includes a top face 46, a bottom face 48, a leading face 50 and a trailing face 52. As best shown, in FIG. 19, the leading face 50 extends angularly, downwardly and rearwardly, from the top face 46, toward the bottom face 48. Together with the chipping portion 40 of the knife holder 14a, the leading face 50 of the finishing portion 38 defines an evacuation channel 54 (see FIG. 8) for directing wood chips away from the finishing knife 30 during the operation of the canter head 10, as it will be described in greater detail below.

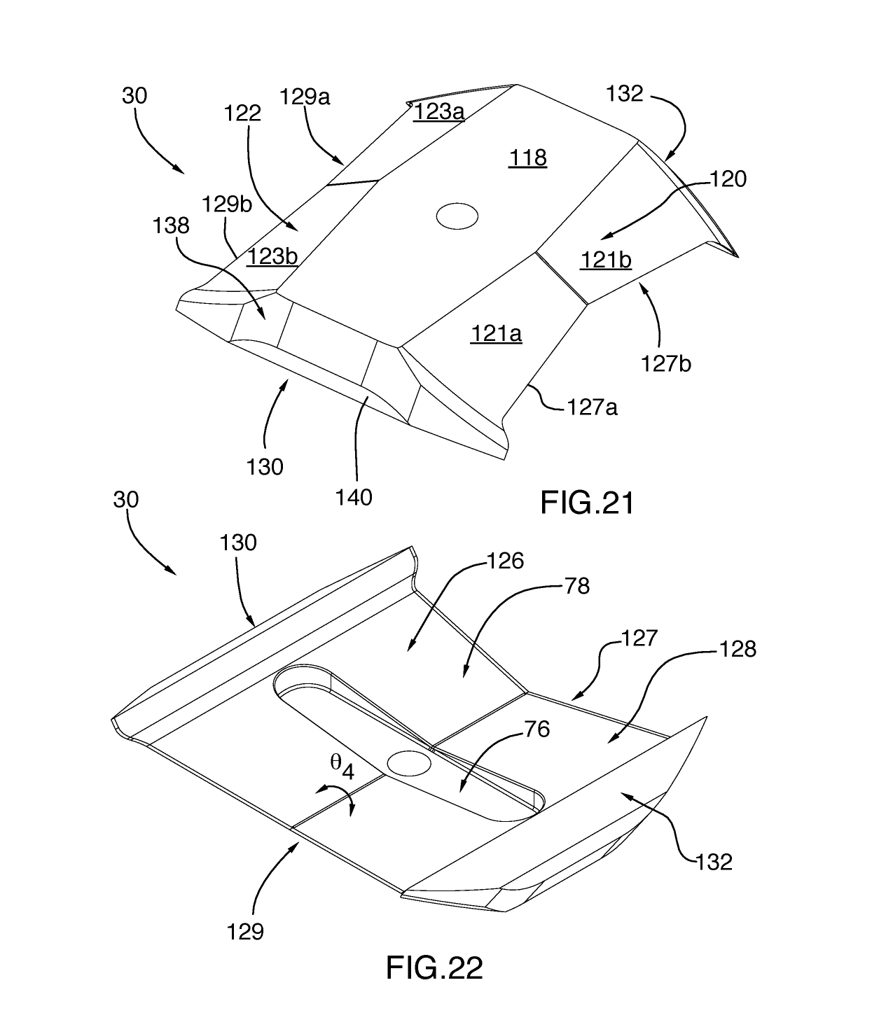

Still referring to FIGS. 18 to 20, the top face 46 of the finishing portion 38 is configured to collaborate with the finishing knife 30 and finishing knife clamp 34 for maintaining the finishing knife 30 into its operating position during the operation of the canter head 10. More specifically, the top face 46 of the finishing portion 38 extends from the leading face 50 toward the trailing face 52. The top face 46 is configured to define a receptacle 56 for receiving the finishing knife 30, and clamping the same between the knife holder 14a and the knife clamp 34, together with the trailing face 52. More specifically, the receptacle 56 includes a first portion 58 mating, or complementary to, a bottom face 78 of the finishing knife 30 (best shown in FIGS. 18 and 22). In the illustrated embodiment, the first portion 58 of the receptacle 56 includes a pair of L-shaped angled face portions 62, 64 defining an upwardly extending V-shape, as well as a generally rectangular fastener portion 66. Defined in the rectangular fastener portion 66 is a threaded bore 68 for receiving a threaded fastener 70, in order to secure the finishing knife clamp 34 to the knife holder 14a using a nut 72, as it will become apparent below.

Extending upwardly from the two L-shaped angled faces 62, 64 is an oblong projection 74, extending longitudinally along the radial axis of the finishing portion 38 of knife holder 14a, and configured to engage a complementary oblong recess 76 defined on a bottom face 78 of the finishing knife 30. Defined on each side of the receptacle 56 are channels 80, 82 for receiving angular flanges 130, 132 extending downwardly on each side of the finishing knife 30 (shown in FIGS. 18 and 22), as it will be described in greater detail below.

Located at the rear end of the top face 46 of the finishing portion 38 is a pivot receiving portion 88 for receiving a portion of the finishing knife clamp 34 and allowing the same to pivot to clamp the finishing knife 30 in operating position, as it will become apparent below (see FIG. 18). In the illustrated embodiment, the pivot receiving portion 88 comprises an angled face 90 defining an angle θ₂ with the top face 46, and a curved face 92 defining somewhat of a semi-cylindrical recess to receiving a portion of the finishing knife clamp 36, as described in greater detail below.

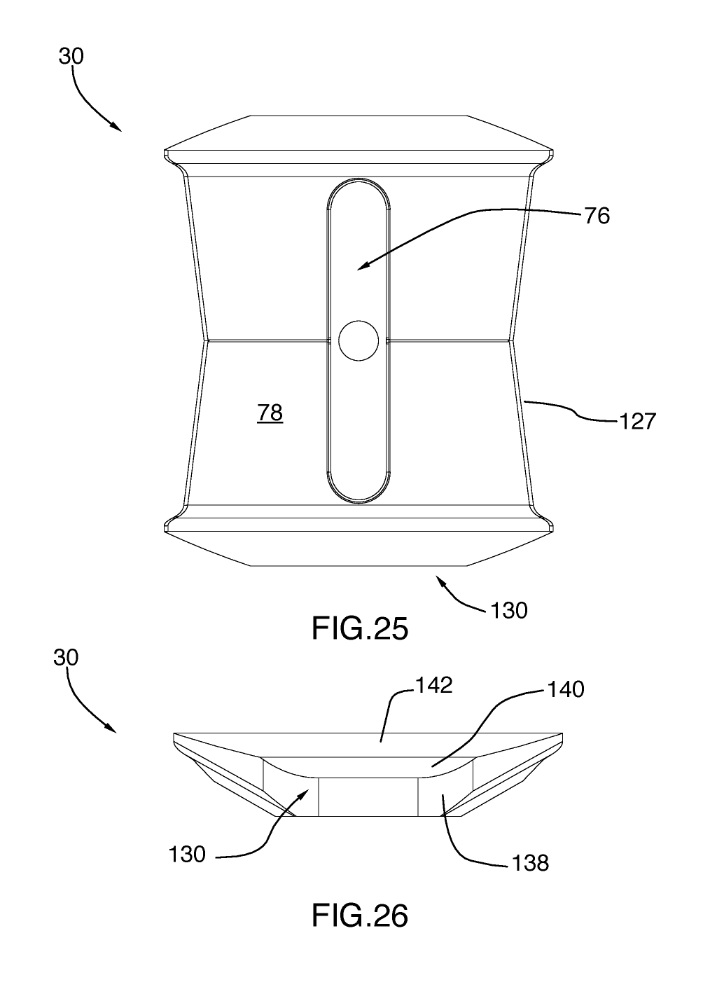

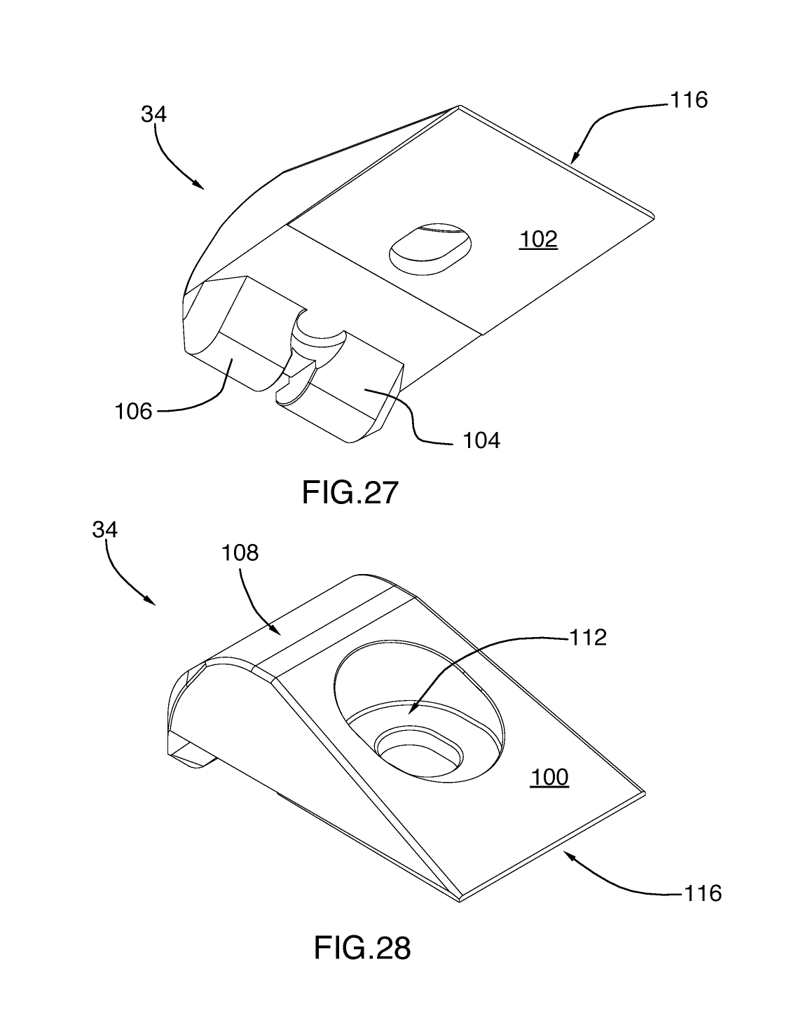

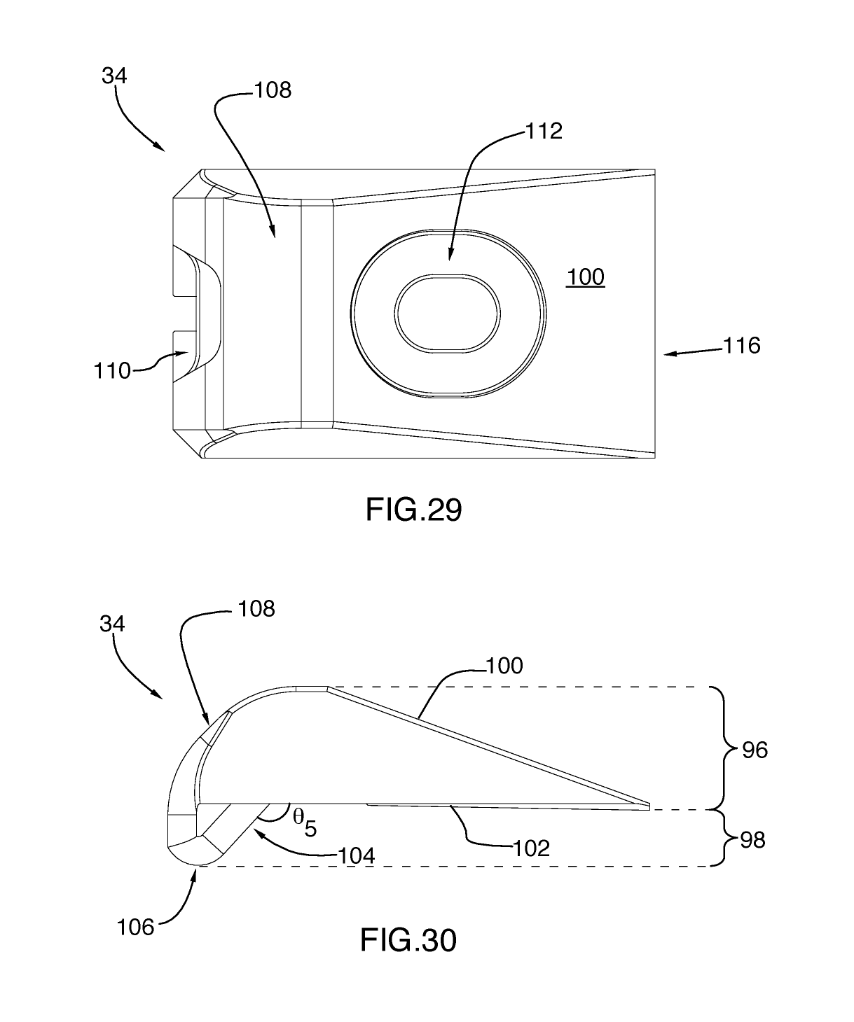

Turning now to FIGS. 21 to 26, the reversible finishing knife 30 will now be described. Reversible finishing knife 30 includes an elongated hexagonal top face 118, a leading face 120, a trailing face 122 (which becomes a leading face when the knife is positioned in the reversed position) and bottom face 78 comprising a left portion 126 and a right portion 128. Moving from the back to the front of the knife 30, leading face 120 tapers toward bottom face 78 to terminate into leading cutting edges 127a and 127b. Conversely, moving from the front to the back of knife 30, trailing face 122 tapers toward bottom face 78 to terminate into trailing cutting edges 129a and 129b.

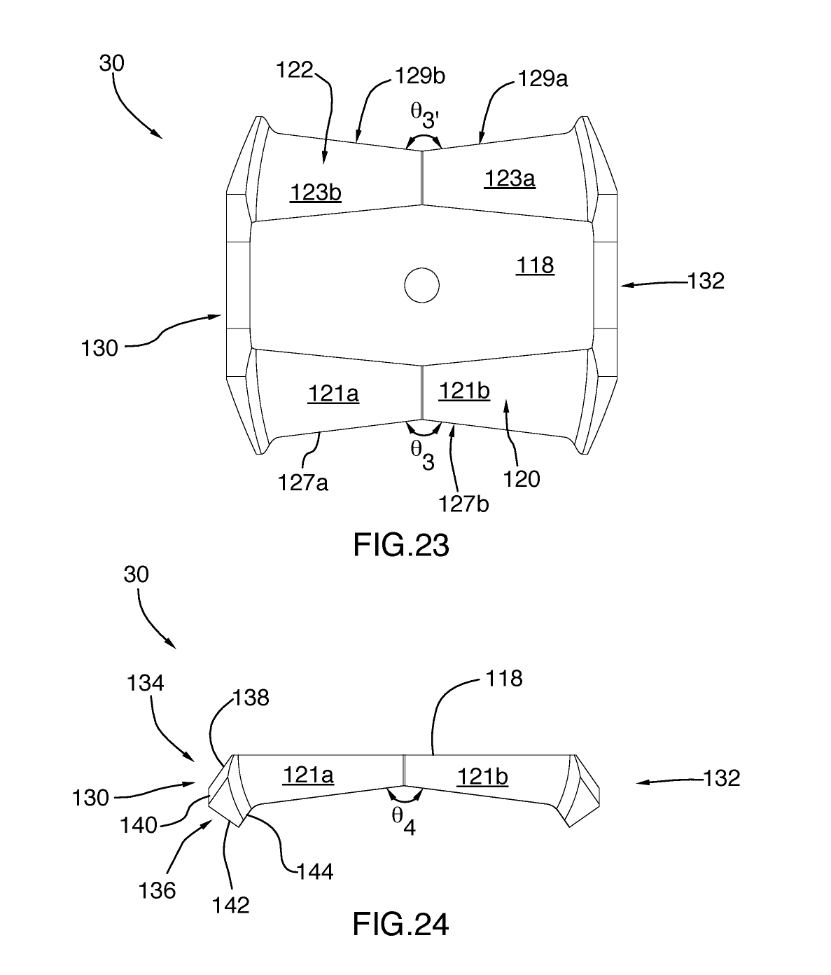

As best shown in FIG. 23, leading cutting edges 127a and 127b extend at an angle θ₃ relative to one another. Likewise, trailing cutting edges 129a and 129b extend at an angle θ₃′, relative to one another. In one embodiment, the angles θ₃ and θ₃′ range between 165 and 175 degrees. Preferably, the angles θ₃ and θ₃′ are about 170 degrees.

Returning to FIG. 22, left and right portions 126, 128 of the bottom face 124 extend at an angle θ₄ relative to one another and define a V-shape complementary to the V-shape defined by the L-shaped faces 62, 64 of the receptacle 56 defined on the top face 46 of finishing portion 38. In one embodiment, the angle θ₄ ranges between 160 degrees and 175 degrees. Preferably, the angle θ₄ is about 170 degrees. Defined on the bottom face 78 of the finishing knife 30 is the oblong recess 76, sized and shaped to receive therein the oblong projection 74 of the knife holder 14a. The oblong recess 76 longitudinally extends between the two sides of the finishing knife 30, halfway between the leading edges 127a, 127b and the trailing edges 129a, 129b of the finishing knife 30. When the finishing knife 30 is properly positioned on the knife holder 14a, the oblong projection 74 engages the oblong recess 76, and the V-shaped bottom face 78 of the finishing knife 30 rests against the complementary V-shaped top face 46 of the finishing knife portion 38 of knife holder 14a. While in the illustrated embodiment the projection 74 and recess 76 have complementary oblong shapes, the person skilled in the art will appreciate that any other geometrical shapes that are symmetrical from front to rear would be suitable. For instance, the projection 74 and recess 76 could have a square, rectangular, hexagonal or any other suitable shape.

Alternatively, instead of having only one projection 74 and only one corresponding recess 76, the finishing portion 38 of knife holder 14a could be provided with multiple projections shaped and positioned to allow finishing knife 30 to be placed on the finishing portion 38 in forward and reverse position (not shown). In such an embodiment, the bottom face 78 of the finishing knife 30 would be provided with a number of recesses shaped and positioned to allow the finishing knife 30 to be placed on the finishing portion 38 in a forward or reverse position. In a further embodiment, a projection would extend downwardly from the bottom face 78 of the finishing knife 30, and would be engageable in a corresponding recess defined on the finishing portion 38 of the knife holder 14a (not shown).

Extending on each side of the finishing knife 30, between the leading edges 127a, 127b and the trailing cutting edges 129a, 129b, are left and right flanges 130, 132, respectively. Left and right flanges 130, 132 being mirror images of one another, only left flange 130 will be described. The person skilled in the art will appreciate that a similar description also applies to right flange 132, with proper adaptations. As best shown in FIG. 24, left flange 130 includes a top portion 134 and a wedge-shaped bottom portion 136 projecting downwardly from the bottom face 78 of finishing knife 30. The top portion 134 includes a first angled face 138 extending downwardly, and at an angle from the top, leading and trailing faces 118, 120, 122. It also includes a generally vertical face 140. The first angled face 138 and the vertical face 140 connect the top, leading and trailing faces 118, 120, 122 of the finishing knife 30 to an exterior face 142 of the bottom portion 136. In addition to the exterior face 142, the bottom portion 136 of the left flange 130 includes an interior face 144. Together, the exterior face 142 and the interior face 144 of the bottom portion 136 define the wedge shape. As it will be described in greater detail below, the exterior face 142 of the bottom portion 136 is configured to adjoin a side face 146 of the chipping knife 32 when they are both secured to the knife holder 14a, as well as a side face 148 of the chipping portion 40 of knife holder 14a.

To secure the finishing knife 30 to the finishing portion 38 of knife holder 14a, the finishing knife 30 is positioned in the receptacle 56 defined on the top face 46, with the oblong projection 74 engaging the oblong recess 76 defined on the bottom face 78 of finishing knife 30. At that point, the bottom face 78 of the finishing knife 30 lies against the L-shaped portions 62, 64 of the receptacle 56. The finishing knife clamp 34 is then positioned onto the finishing knife portion 38 of knife holder 14a to maintain finishing knife 30 in operating position.

More specifically, the finishing knife clamp 34 includes an upper wedge portion 96 and a lower pivot portion 98 (seen in FIG. 30). The upper wedge portion 96 includes a top face 100 and a bottom face 102, and the lower pivot portion 98 extends downwardly from the bottom face 102 of the wedge portion 96. The lower pivot portion 98 is receivable in the pivot receiving portion 88 of the finishing knife portion 38 and includes an angled face 104 and a lower curved face 106, complementary to the curved face 92 of the pivot receiving portion 88. The angled face 104 defines an angle θ₅ with the bottom face 102 of the wedge portion 96. A curved trailing face 108 connects the lower curved face 106 to the top face 100 of the wedge portion 96. Defined in the trailing face 108 of the finishing knife clamp 34 is a recess 110 for receiving a clamp fastener (not shown) to facilitate the assembly of the finishing knife clamp 34 to the knife holder 14a. To allow securing the knife clamp 34 to the finishing portion 38 of knife holder 14a, a flanged hole 112 is provided. In the illustrated embodiment, flanged hole 112 extends from the top face 100 of the wedge portion 96 to the bottom face 102, and is adapted to receive threaded fastener 70 and nut 72.

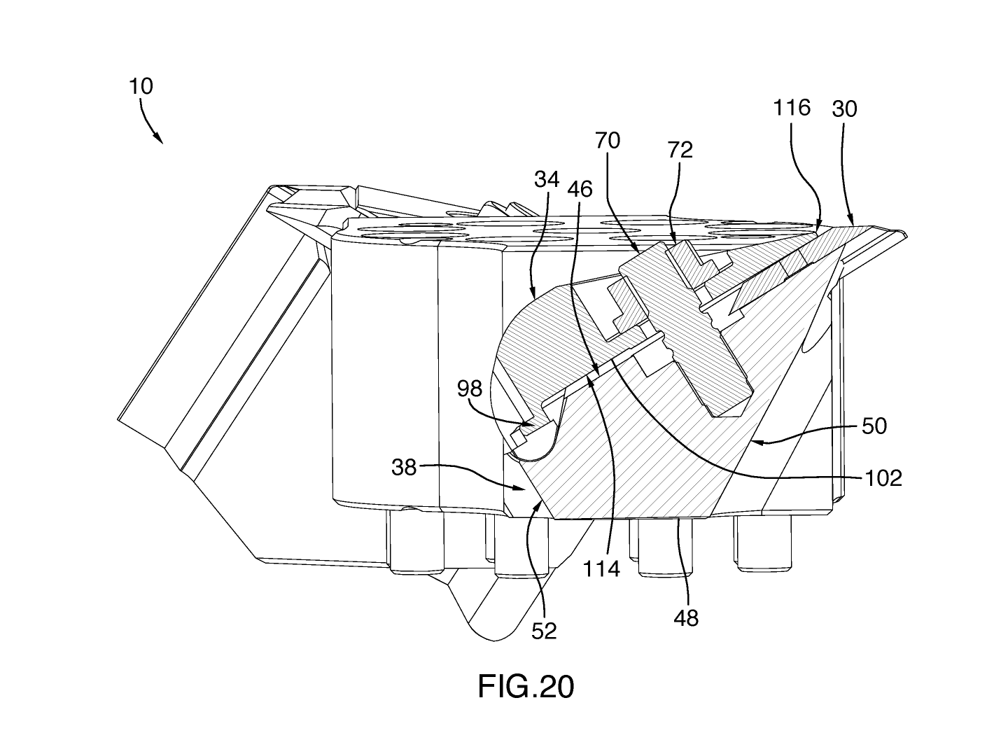

As best shown in FIGS. 19 and 20, the lower pivot portion 98 of the finishing knife clamp 34 is slightly longer than pivot receiving portion 88 of the finishing portion 38 of knife holder 14a, such that a space 114 is defined between the bottom face 102 of the wedge portion 96 of the knife clamp 34 and the top face 46 of the finishing portion 38 of knife holder 14a. Furthermore, the angle θ₅ defined by the angled face 104 of the lower pivot portion 108 of the knife clamp 34 is slightly more open than angle θ₂ defined by the top face 46 of the finishing portion 38 of knife holder 14a. As such, a leading end 116 of the finishing knife clamp 34 can move up and down relative to the knife holder 14a, to clamp the finishing knife 30 between the finishing knife clamp 34 and the knife holder 14a, using the threaded fastener 70 and the nut 72.

The threaded fastener 70 is then engaged in the flanged hole 112 of the knife clamp 34 and is secured into the threaded bore 68. The nut 72 is then secured on the threaded fastener 70, to urge the finishing knife clamp 34 against the hexagonal top face 118 of the knife 30, thereby securing finishing knife 30 to knife holder 14a. In this position, the oblong projection 74 is engaged in the oblong recess 76 of the finishing knife 30, thereby preventing unwanted movement thereof relative to support 14a (best shown in FIGS. 19 and 20). To position the finishing knife 30 in a reversed position, nut 72 is unscrewed and finishing knife clamp 38 is removed. Finishing knife 30 can then be repositioned in the reverse position, and knife clamp and nut 72 are repositioned on knife holder 14a.

As best shown in FIG. 3, when finishing knife 30 is in the forward position on the finishing portion 38 of the knife holder 14a, face 121a of the finishing knife 30 extends generally parallel to the plan defined by axis L₁ while face 121b extends slightly downwardly relative to the plan of axis L₁, at an angle θ₆. In one embodiment, angle θ₆ ranges between 0 and 10 degrees, and is preferably about 5 degrees. As it will be appreciated by the person skilled in the art, this positioning of finishing knife 30 on knife holder 14a is such that only face 121a of finishing knife 30 is exposed for chipping wood while face 121b remains substantially unexposed, when used in connection with canter head 10 rotating in counter-clockwise direction. As such, finishing knife 30 can further be used in connection with a canter head 11 configured to rotate in a clockwise direction (see FIG. 1B) when face 121a has rounded up and is no longer usable. On such a canter head 11 rotating in a clockwise direction, unused face 121b now extends substantially parallel to the plan defined by axis L₁ and is exposed for chipping wood while rounded up face 121a now extends slightly downwardly, at angle θ₆, and is unexposed and non-operational.

Likewise, when finishing knife 30 is in the reversed position on the finishing portion 38 of the knife holder 14a, face 123a of the finishing knife 30 extends generally parallel to the plan defined by axis L₁ while face 123b extends slightly downwardly relative to the plan of axis L₁, at angle θ₆. As it will be appreciated by the person skilled in the art, this positioning of finishing knife 30 on knife holder 14a is such that only face 123a of finishing knife 30 is exposed for chipping wood while face 123b remains substantially unexposed, when used in connection with canter head 10 rotating in counter clockwise direction. As such, finishing knife 30 can further be used in connection with a canter head 11 configured to rotate in a clockwise direction (see FIG. 1B) when face 123a has rounded up and is no longer usable. On such a canter head 11 rotating in a clockwise direction, unused face 123b now extends substantially parallel to the plan defined by axis L₁ and is exposed for chipping wood while rounded up face 123a now extends slightly downwardly, at angle θ₆, and is unexposed and non-operational.

The person skilled in the art will appreciate that, instead of first moving the finishing knife 30 from canter head 10 rotating in a counter-clockwise direction to a canter head moving 11 in a clockwise direction to use used the adjacent face (e.g. using face 121a and then 121b), it is possible to first reposition the finishing knife 30 initially in forward position such that it becomes in the reverse position, such that face 121a is used and then face 123a, before moving the finishing knife to the clockwise rotating canter head.

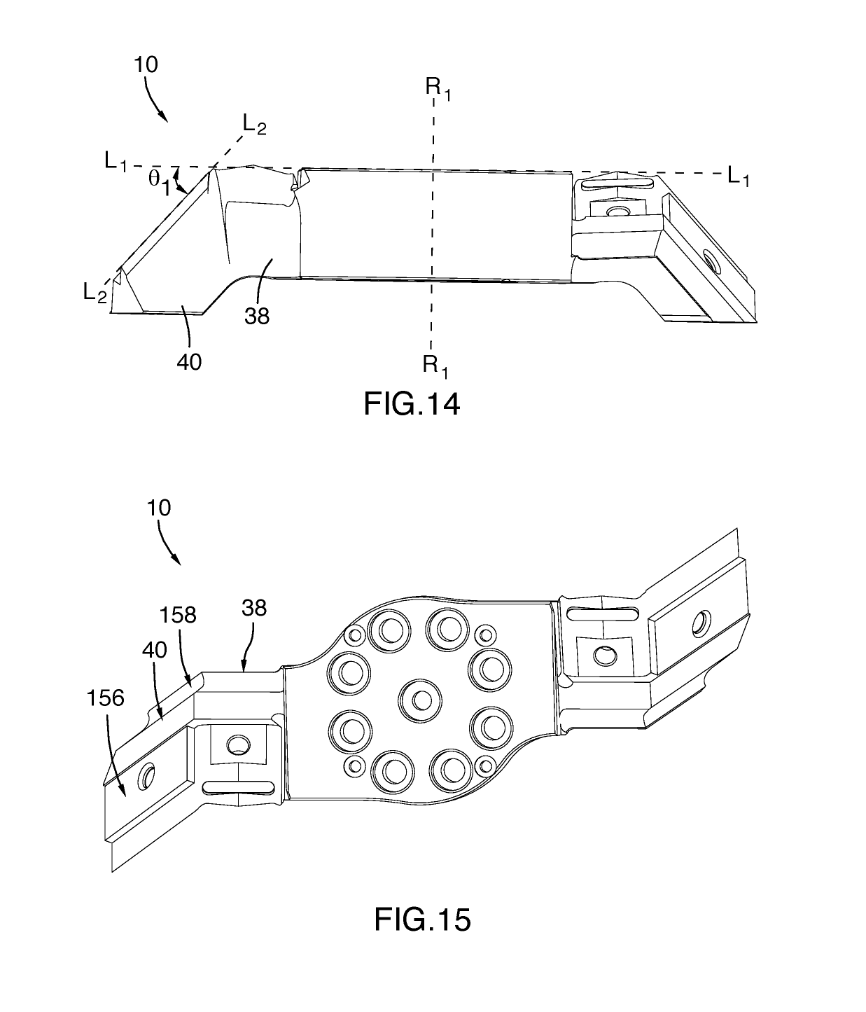

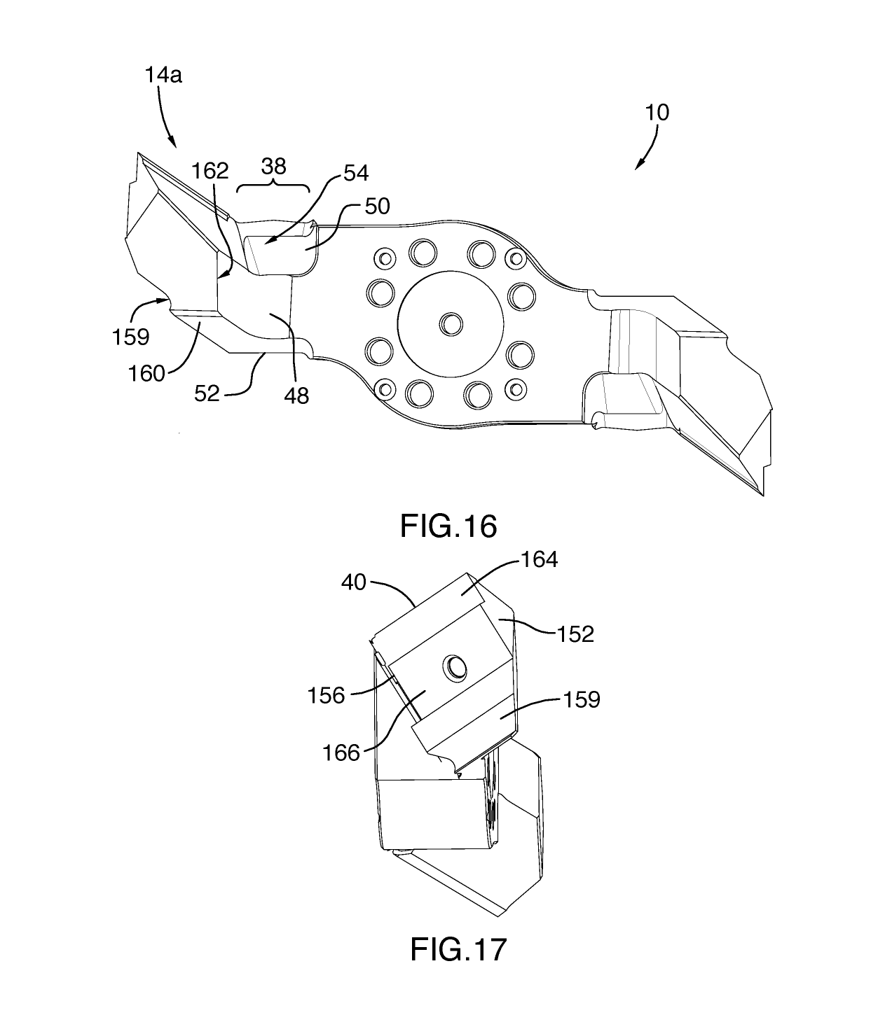

Returning to FIGS. 12 to 18, the chipping portion 40 of the knife holder 14a will be described in accordance with one embodiment. In this embodiment, the chipping portion 40 of the knife holder 14a has a generally wedge shape and includes a right end 150 attached to the left end 44 of the finishing portion 38, a left end 152, and a leading face 154 (see FIGS. 13 and 18). Together with the leading face 50 of the finishing portion 38, the leading face 154 of the chipping portion 40 defines evacuation channel 54 (see FIGS. 8 and 16) for directing wood chips away from the finishing and chipping knives 30, 32. Returning to FIGS. 16 and 18, the chipping portion 40 also includes a top face 156, a pivot receiving portion 158 including a curved face 159, a trailing face 160 and a bottom face 162. Defined in the top face 156 is a rectangular chipping knife receiving recess 164, as well as a rectangular fastener receiving portion 166.

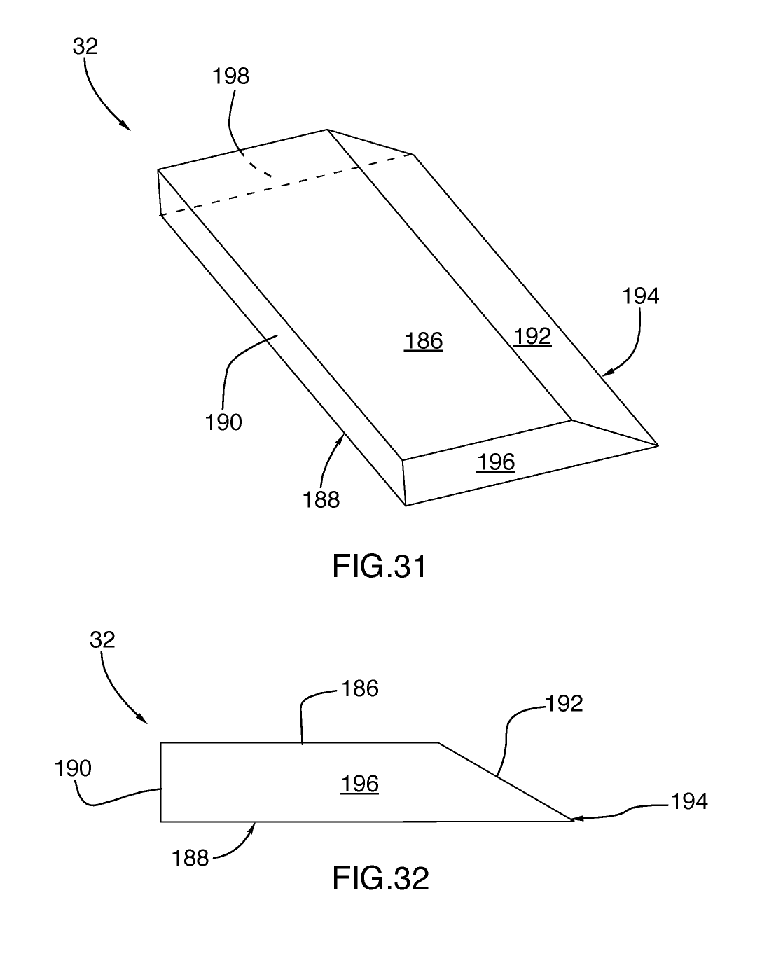

Turning now to FIGS. 31 and 32, the chipping knife 32 is of a typical configuration and includes a rectangular top face 186, a rectangular bottom face 188, a back face 190 extending between the top face 186 and the bottom face 188, perpendicularly thereto, and a leading face 192 defining a wedge and terminating into a cutting edge 194. The chipping knife 32 also includes left and right side faces 196 and 198, respectively.

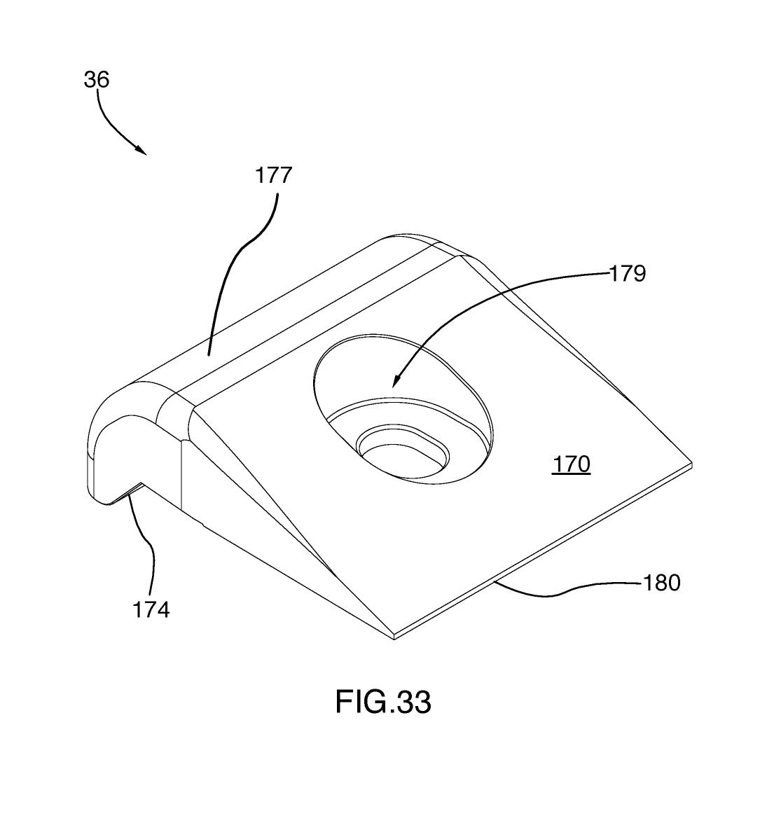

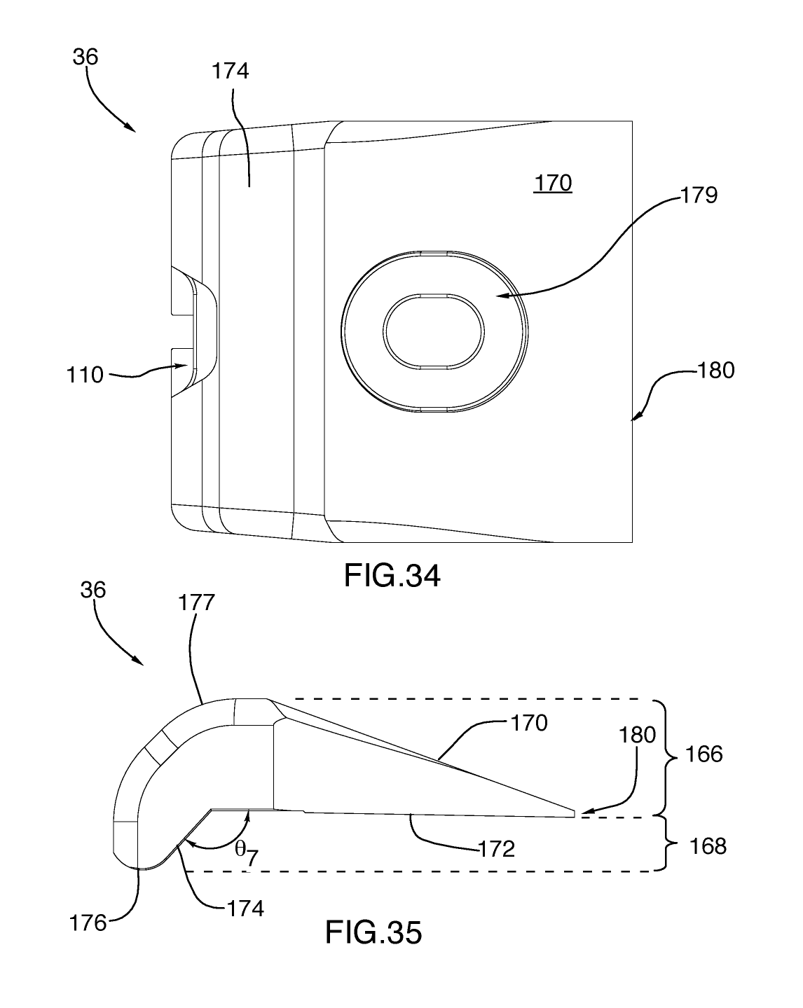

Much like the finishing knife clamp 34, the chipping knife clamp 36 includes an upper wedge portion 166 and a lower pivot portion 168 (see FIGS. 33 to 35). The upper wedge portion 166 includes a top face 170 and a bottom face 172, and the lower pivot portion 168 extends downwardly from the bottom face 172 of the wedge portion 166. The lower pivot portion 168 also includes an angled face 174 and a lower curved face 176, complementary to the curved face 159 defined in the pivot receiving portion 158. A curved trailing face 177 connects the lower curved face 176 to the top face 170 of the wedge portion 166.

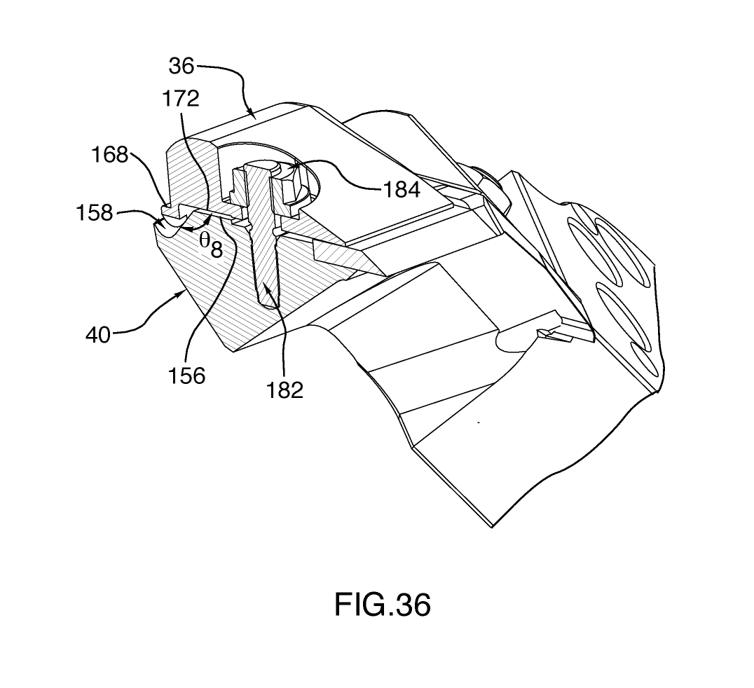

As for the finishing knife clamp 34, the lower pivot portion 168 of the chipping knife clamp 36 is slightly longer than the pivot receiving portion 158 of the chipping portion 40, such that a space is defined between the bottom face 172 of the wedge portion 166 of the chipping knife clamp 36 and the top face 156 of the chipping knife portion 40 of knife holder 14a (see FIG. 36). Furthermore, an angle θ₇ defined by the angled face 174 of the lower pivot portion 168 relative to the bottom face 172 of the wedge portion 166 is slightly more open than another angle θ₈ defined by the top face 156 of the chipping portion 40 and the angled face 174 of the pivot receiving portion 158. As such, a leading end 180 of the chipping knife clamp 36 can move up and down relative to the chipping knife portion 40 to clamp the chipping knife 32 between the chipping knife clamp 36 and the chipping knife portion 40 of the knife holder 14a, using a threaded fastener 182 and a nut 184.

As can be seen on FIG. 9, once finishing knife 30 and the chipping knife 32 are properly positioned onto the finishing and chipping portions 38, 40 of the knife holder 14a, and are properly secured with finishing knife clamp 34 and chipping knife clamp 36, the flanges 130, 132 of the finishing knife 30 are received in the channels 80, 82 of the receptacle 56 on the top face 46 of the finishing portion 38. Furthermore, the right side face 198 of the chipping knife 32 abuts the exterior face 142 of the bottom portion 136 of the left flange 130 of finishing knife 30, therefore assuring continuity between finishing knife 30 and chipping knife 32 to define the evacuation channel 54.

While in the illustrated embodiment, the canter heads 10 and 11 each include two knife holders 14a, 14b, and a corresponding number of pairs of knives (each pair including a finishing knife 30 and a chipping knife 32), the person skilled in the art will appreciate that a canter head could be provided with a different number knife holders and corresponding pair of knives. The person skilled in the art will appreciate that with such an alternate configuration, the different knife holders are preferably distributed evenly about the periphery of the hub such that the canter head is properly balanced when rotating about the rotation axis, during the operation of the canter head. In an alternate embodiment of a canter head, the canter head comprises between two and ten knife holders.

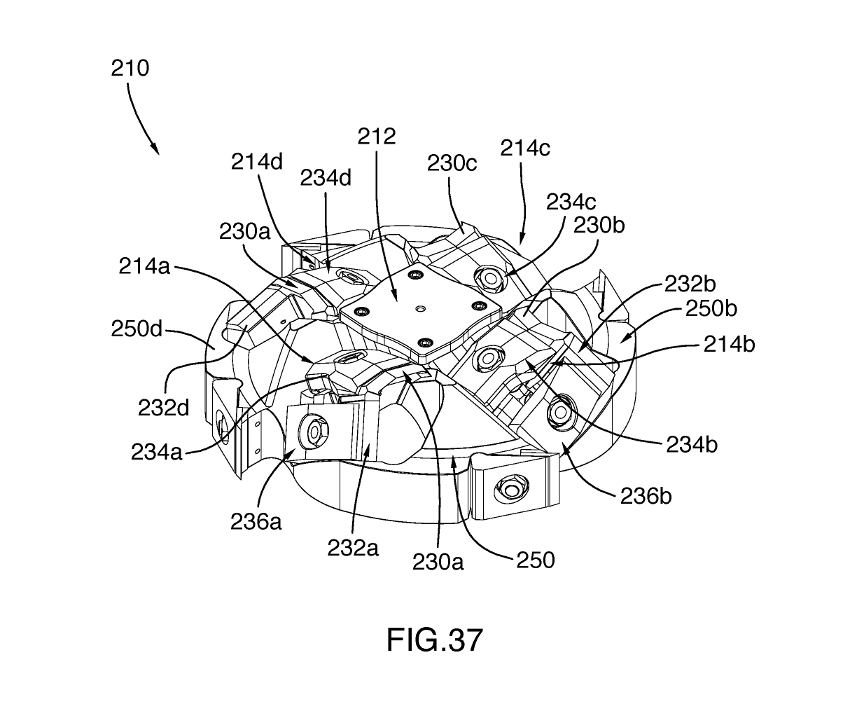

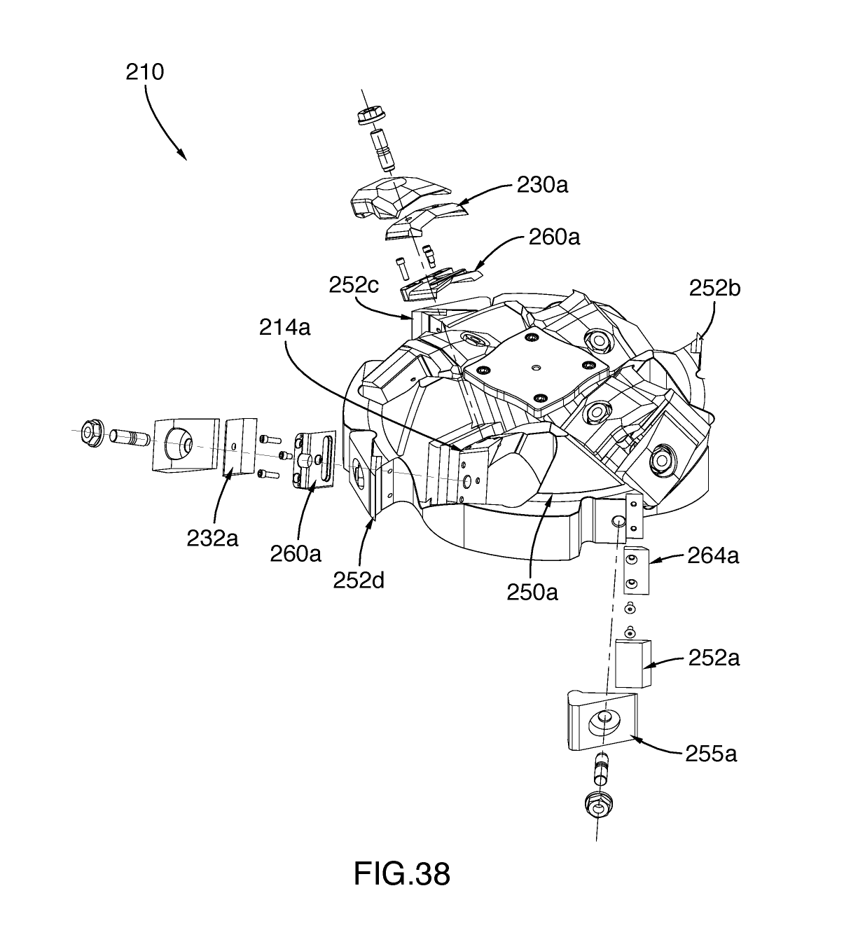

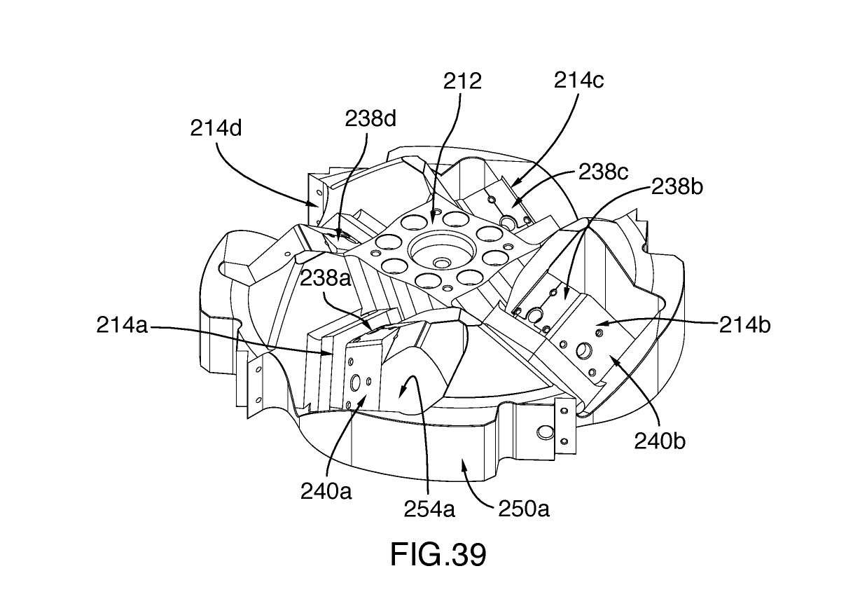

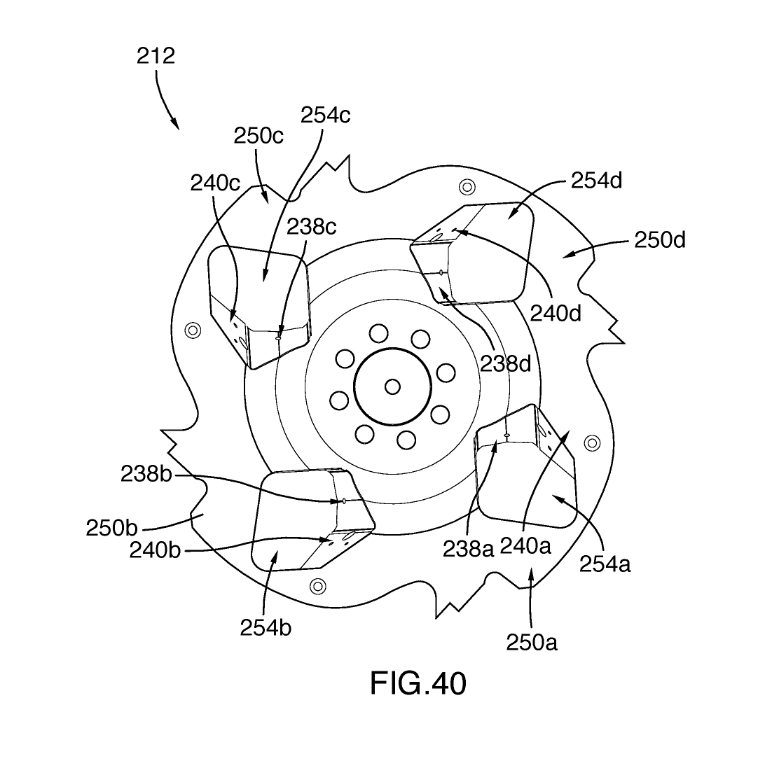

Such an alternate embodiment of a canter head 210 is shown in FIGS. 37 to 43. In this embodiment, canter head 210 includes a central hub 212 and four knife holders 214a-214d which extend radially outwardly from the hub 212. Like support arms 14a, 14b of canter head 10, each of the four knife holders 214a-214d comprises a finishing portion (238a-238d) and a chipping portion (240a-240d), on which are respectively mounted finishing knives (230a-230d) and chipping knives (232a-232d) secured by way of finishing knife clamps (234a-234d) and chipping knife clamps (236a-236d). In the illustrated embodiment, finishing portions (238a-238d), chipping portions (240a-240d), finishing knives (230a-230d) and chipping knives (232a-232d) finishing knife clamps (234a-234d) and chipping knife clamps (236a-236d) have the general configurations of finishing portion 38 and chipping portion 40, finishing knife 30 and chipping knife 32, finishing knife clamps 34 and chipping knife clamps 36 of canter head 10. Furthermore, each of the four knife holders 214a-214d comprises radial knife holder 250a-250d configured to receive radial knives 252a-252d. In the illustrated embodiment, each of the radial knives 252a-252d has the general configuration of the chipping knives 232a-232d and include a cutting edge, which extends parallel to the rotation axis of canter head 210 during its operation. Radial knives 252a-252d are mounted to canter head 210 by way of radial knife clamps 255a-255d. Each of the radial knife holders (e.g. radial knife holder 250a) connects the end of a chipping portion (e.g. chipping portion 240a) to the chipping portion of the adjacent knife holder (e.g. chipping portion 240b), and defines a channel or passage 254a-254d for allowing wood chips to travel away from finishing knives (230a-230d) and chipping knives (232a-232d) during the operation of canter head 210.

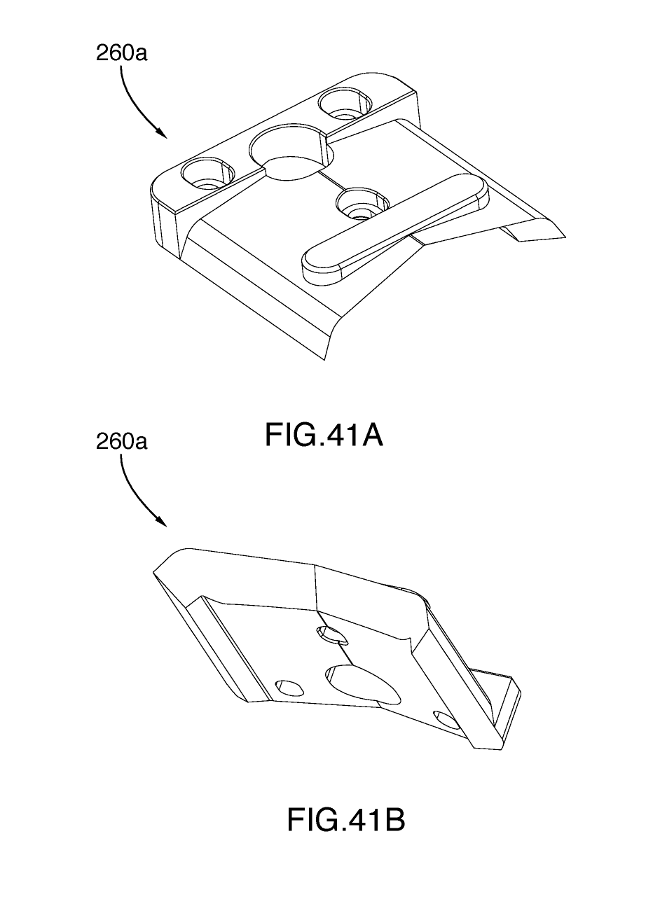

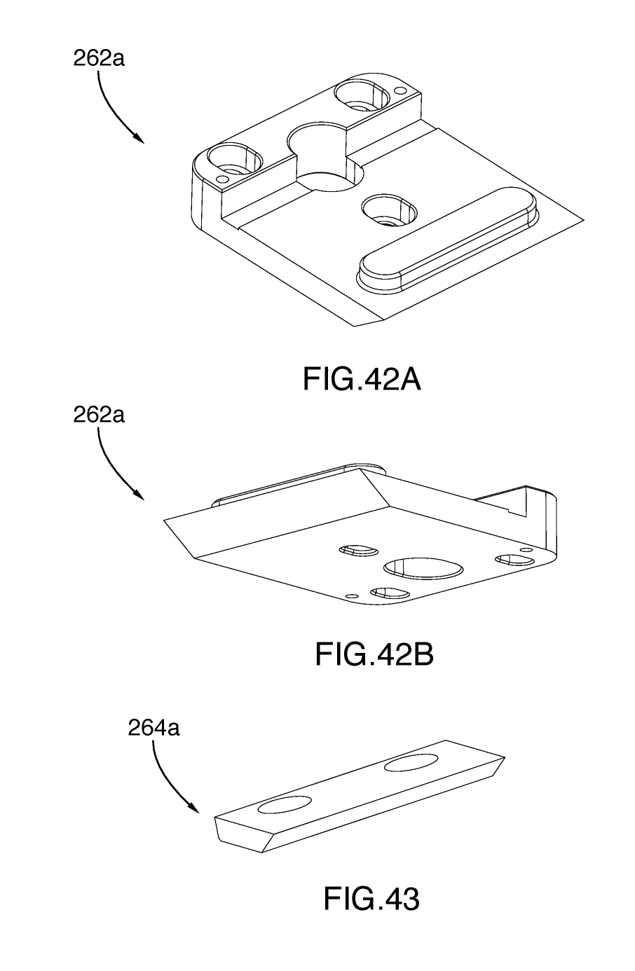

Furthermore, while finishing knives 30 and chipping knives 32 of canter head 10 were positioned directly onto the finishing portion 38 and chipping portion 40 of support arms 14a, 14b, canter head 210 makes use of finishing adaptors 260a-260d (see FIGS. 41A and 41B) and chipping adaptors 262a-262d (see FIGS. 42A and 42B) for positioning finishing knives (230a-230d) and chipping knives (232a-232d) onto finishing portions (238a-238d) and chipping portions (240a-240d) of knife holders 214a-214d. Likewise, radial knives 252a-252d are mounted to radial knife holders 250a-250d using radial knife adaptors 264a-264d.

The person skilled in the art will appreciate that there exist multiple ways to manufacture the components of canter head 10 and 210. In one embodiment, all of these or some of the components are manufactured by machining, for instance using a 5-Axis CNC machine.

The embodiments described above are intended to be exemplary only. The scope of the invention is therefore intended to be limited solely by the appended claims.

1. A canter head comprising:
a. a hub;
b. at least one knife holder attached to the hub and including a finishing portion and a chipping portion, the finishing portion including a receptacle for receiving one finishing knife;
c. at least one reversible finishing knife receivable in the receptacle of the at least one knife holder, the at least one reversible finishing knife including a leading edge and a trailing edge;
d. at least one projection extending from one of the reversible finishing knife or the receptacle;
e. at least one recess defined in the other of the reversible finishing knife or the receptacle, the at least one recess being configured to receive the at least one projection therein for preventing unwanted movement of the finishing knife relative to the knife holder during the operation of the canter head, the at least one projection and the corresponding at least one recess being configured to allow the leading edge and the trailing edge of the finishing knife to be in a forward operating position;
f. at least one finishing knife clamp mountable to the finishing portion of the at least one knife holder, the at least one finishing knife clamp being configured for clamping the at least one finishing knife onto the finishing portion of the at least one knife holder;
g. at least one chipping knife mountable to the chipping portion of the at least one knife holder; and
h. at least one chipping knife clamp mountable to the chipping portion of the at least one knife holder, the at least one chipping knife clamp being configured for clamping the at least one chipping knife onto the chipping portion of the at least one knife holder.

2. A canter head according to claim 1, wherein the finishing portion of the knife holder includes a receptacle having a top face and the finishing knife comprises a bottom face and a top face extending between the leading edge and the trailing edge, the bottom face of the finishing knife being configured to mate with the top face of the receptacle.

3. A canter head according to claim 2, wherein the top face of the receptacle defines a V-shape and the bottom face of the finishing knife define a complementary V-shape.

4. A canter head according to claim 1, wherein the at least one projection extends upwardly from the finishing knife portion and the recess is defined on the finishing knife.

5. A canter head according to claim 1, wherein the at least one projection has an oblong shape and the at least one recess has a complementary oblong shape.

6. A canter head according to claim 2, wherein the receptacle includes a pair of spaced-apart channels and the finishing knife includes a pair of spaced-apart flanges, the spaced-apart flanges of the finishing knife being receivable in the spaced-apart channels of the receptacle.

7. A canter head according to claim 1, wherein the canter head comprises two knife holders.

8. A canter head according to claim 7, wherein the two knife holders extend from the hub in radially opposed directions.

9. A canter head according to claim 1, wherein the canter head comprises four knife holders.

10. A reversible finishing knife for a canter head comprising at least one knife holder attached to a hub, the knife holder including a finishing portion, the finishing portion including a receptacle for receiving the finishing knife, the reversible finishing knife comprising a leading edge and a trailing edge, and at least one of a projection and a recess configured to engage a complementary recess or projection on the at least one knife holder.

11. A reversible finishing knife according to claim 10, wherein the at least one projection extends from the knife holder and the at least one corresponding recess is defined in the finishing knife.

12. A reversible finishing knife according to claim 10, wherein the at least one projection comprises an oblong projection.

13. A reversible knife according to claim 10, wherein the finishing knife comprises a pair of flanges, each flange extending on one side of the finishing knife, between the leading edge and the trailing edge thereof.
